(19) United States
(12) Patent Application Publication
(10) Pub. No.: US 2006/0072865 A1
(43) Pub. Date: Apr. 6, 2006

(54) Bearing unit for supporting wheel with disk and method manufacturing bearing unit

(75) Inventor: Masayoshi Shimizuya, KANAGAWA (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD., TOKYO (JP)

(21) Appl. No.: 10/535,660

(22) PCT Filed: Nov. 14, 2003
(86) PCT No.: PCT/JP03/14536

§ 371 Date: May 19, 2005

(30) Foreign Application Priority Data
Jan. 27, 2003 (JP) 2003-17047

(51) Int. Cl. F16C 13/00

(52) U.S. Cl. 384/544

(57) ABSTRACT

The mutual difference of the diameters of the balls 17, 17 incorporated into a bearing unit for supporting a wheel is set to be not more than 1.5 μm (preferably to be not more than 1.0 μm). Finishing work is conducted on both sides of the disk 2 under the condition that the bearing unit for supporting a wheel is assembled and further this disk 2 is attached to the attaching flange 13 of the bearing unit for supporting a wheel. Due to the foregoing, the whirl of the hub 8 with respect to the outer ring 6 caused by the revolution of the balls 17, 17 can be suppressed, and at the same time an influence of the error of each portion can be eliminated. Therefore, the deflection of both sides 24, 24 of the disk 2 can be suppressed to be a sufficiently low value of not more than 35 μm (preferably not more than 25 μm).

### TECHNICAL FIELD

The present invention relates to a bearing unit for supporting a wheel having a disk which supports the wheel of an automobile and constitutes a disk brake used for braking the automobile. The present invention also relates to a manufacturing method of manufacturing the bearing unit.

### BACKGROUND ART

For example, as shown by the structure illustrated in FIG. 1, the wheel 1 of an automobile and the disk 2 of a disk brake, which is a braking device, are pivotally supported by the knuckle 3 constituting a suspension device. That is, the outer ring 6, which is a stationary ring, constituting the bearing unit 5 for supporting a wheel having a disk, which is an object of the present invention, are fixed to the circular support hole 4, which is formed in the knuckle 3, by a plurality of bolts 7. On the other hand, the wheel 1 and the disk 2 are coupled and fixed to the hub 8, which is a rotary ring and a shaft member relating to the present invention and constitutes the bearing unit 5 for supporting a wheel having a disk, by a plurality of stud bolts 9 and nuts 10.

A plurality of outer ring raceways 11a, 11b, which are stationary side raceway surfaces, are formed on an inner circumferential face of the outer ring 6, and the coupling flange 12 is formed on an outer circumferential face of the outer ring 6. The thus outer ring 6 is fixed to the knuckle 3 by coupling the coupling flange 12 to the knuckle 3 by the bolts 7.

On the other hand, in a portion of the outer circumferential face of the hub 8, which protrudes from an outside end opening of the outer ring 6, the attaching flange 13 corresponding to the flange of the present invention is formed. In this case, concerning the axial direction, the outside is defined as the outside in the width direction when the bearing unit is assembled to an automobile, that is, the outside is defined as the left in FIGS. 1 and 3, and the outside is also defined as the upper side in FIG. 2. On the contrary, the inside is defined as the right in FIGS. 1 and 3, and the inside is also defined as the lower side in FIG. 2, that is, the inside is defined as a side which becomes an inside in the width direction when the bearing unit is assembled to an automobile. This definition is common in the entire specification. The wheel 1 and the disk 2 are coupled and fixed to the outside of the attaching flange 13 by the stud bolts 9 and the nuts 10. On the outer circumferential face in the middle portion of the hub 8 opposing to the outer ring raceway 11a, which is one of the double raw outer ring raceways 11a, 11b and located outside, the inner ring raceway 14a is directly formed. Further, in the small diameter step portion 15 formed in the inner end portion of the hub 8, the inner ring 16, which is used as an inner ring element of the present invention, is fixed being engaged from the outside. The inner ring raceway 14b formed on the outer circumferential face of this inner ring 16 is opposed to the outer ring raceway 11b which is one of the double row outer ring raceways 11a, 11b located inside.

Between the outer ring raceways 11a, 11b and the inner ring raceways 14a, 14b, a plurality of balls 17, 17 are provided being able to roll freely while the plurality of balls 17, 17 are being held by the cages 18, 18. Due to the above structure, a double angular type ball bearing is constituted. Therefore, inside the outer ring 6, the hub 8 is pivotally supported being capable of freely supporting a radial and a thrust load. In this connection, between the inner circumferential faces at both end portions of the outer ring 6 and the outer circumferential face of the middle portion of the hub 8 and the outer circumferential face of the inner end portion of the inner ring 16, the seal rings 19a, 19b are respectively provided, so that the space, in which the balls 17, 17 are provided, and the outer space can be shut off from each other. Further, the example shown in the drawing is a bearing unit 5 for supporting a wheel having a disk used for a drive wheel (a rear wheel of FR vehicle, a rear wheel of RR vehicle, a front wheel of FF vehicle, and all wheels of 4WD vehicle), the spline hole 20 is formed at the center of the hub 8. The spline shaft 22 of the constant velocity joint 21 is inserted into this spline hole 20.

When the above bearing unit 5 for supporting a wheel having a disk is practically used, as shown in FIG. 1, the outer ring 6 is fixed to the knuckle 3, and the wheel 1 combined with a tire not shown and the disk 2 are fixed to the attaching flange 13 of the hub 8. When the disk 2, and the support and the calipers not shown fixed to the knuckle 3 are combined with each other, a disk brake used for braking is constituted. At the time of braking, a pair of pads, which are arranged while the disk 2 is being interposed between the pair of pads, are pressed against both sides of this disk 2.

In this connection, it is known that vibration accompanied by unpleasant noise, which is called judder, frequently occurs at the time of braking an automobile. It is known that the causes of such vibration are the non-uniformity of the frictional state between the side of the disk 2 and the lining of the pad and so forth. It is known that one of the causes of such vibration is the deflection of the disk 2. Originally, the side of the disk 2 must make a right angle with the rotary center of the disk 2. However, due to inevitable errors caused in the manufacturing process, it is difficult for the disk 2 to perfectly make a right angle with the rotary center of the disk 2. As a result, when an automobile is running, it is inevitable that the side of the disk 2 somewhat deviates in the direction of the rotary axis (the lateral direction in FIG. 1). When the side of the disk 2 greatly deflects in the direction of the rotary axis, that is, a displacement of the disk 2 is greatly increased, in the case where the lining of the pair of pads are pressed against both side faces of the disk 2, the aforementioned judder is generated. Problems are not limited to this judder. By the deflection of the disk 2, faces of the disk 2 against which the pad linings are pressed are partially abraded. Further, a vehicle body is greatly vibrated at the time of braking.

In order to solve the problems of the generation of judder, it is important that the deflection of the disk 2 in the axial direction is suppressed, that is, it is important that the axial deflection is suppressed. In order to suppress this deflection in the axial direction, it is necessary that the squareness of both sides of the disk 2 with respect to the rotary center of the hub 8 is enhanced. Concerning the technique to enhance the squareness, as disclosed in the specification of the U.S. Pat. No. 6,158,124, which will be referred to as “Patent Document 1” hereafter and also as disclosed in the official gazette of JP-A-2001-180209, which will be referred to as “Patent Document 2” hereafter, it is considered that after the bearing unit for supporting a wheel has been assembled, while the disk is being attached to the bearing unit, the cutting (lathe turning) work is conducted on both sides of the disk.

FIG. 2 is a view showing the prior art described in Patent Document 2. In the case of this prior art, the hub 8a and the outer ring 6 are combined with each other via a plurality of balls 17, 17 so as to constitute a bearing unit for supporting a wheel. In this connection, in the case of the structure shown in FIG. 2, by the caulking portion 29 formed when an inner end portion of the hub 8a used for a shaft member of the present invention is plastically deformed outward in the radial direction, an inner end face of the inner ring 16 is held down, so that this inner ring 16 can be fixed to the hub 8a. After the bearing unit for supporting a wheel has been constituted as described above, the disk 2 is coupled and fixed to the outside (the upper face shown in FIG. 2) of the attaching flange 13, which is provided on the outer circumferential face of the hub 8a, by a plurality of studs 9 and nuts 10 so as to constitute the bearing unit 5a for supporting a wheel having a disk. At this time, in addition to the disk 2, the jig 23 used for driving the disk 2 is also coupled and fixed to the outside of the attaching flange 13. After finishing work has been conducted on both sides 24, 24 of the disk 2 as described later, this jig 23 for driving is detached from the attaching flange 13.

After the disk 2 has been coupled and fixed to the attaching flange 13 as described above, the machining work to machine both sides 24, 24 of the disk 2 according to a predetermined shape and size is conducted by utilizing the attaching surface of the outer ring 6 to the knuckle 3 (shown in FIG. 1), which constitutes the suspension device, as a reference surface. In order to accomplish this object, the inner end portion (the lower end portion shown in FIG. 2) of the outer ring 6 is internally engaged in the support hole 26 formed in the support 25, and one side (the lower face shown in FIG. 2) of the coupling flange 12 formed on the outer circumferential face of the outer ring 6 is made to collide with an upper face of the support 25 and then this coupling flange 12 is coupled and fixed to the support 25 by the bolts 27. While the hub 8a and the disk 2 are being rotated by a drive unit not shown via the jig 23 for driving, both sides 24, 24 of the disk 2 are cut being finished by the tools 28, 28 such as precision machining bites. In the process of this finishing work, the tools 28, 28 are moved in parallel with the upper face of the support 25.

When both sides 24, 24 of the disk 2 are finished as described above while the hub 8a and the disk 2 are being rotated, the squareness of both sides 24, 24 with respect to the rotary center of the hub 8a can be sufficiently enhanced high. As a result, the deflection of both sides 24, 24 of the disk 2 can be suppressed to be small, and the problem of judder generated at the time of braking can be solved or reduced. The prior art described in Patent Document 1 can provide the same action and effect.

In the case of the prior art described in Patent Documents 1 and 2, the deflection of both sides 24, 24 of the disk 2 in the axial direction caused by errors existing between the hub 8, 8a and the disk 2 can be prevented. However, according to the prior art, in the case where the rotary center itself of the hub 8, 8a is whirled, it is impossible to prevent both sides 24, 24 from whirling together with the whirl of the rotary center of the hub 8. On the other hand, the rotary center itself of the hub 8, 8a is whirled according to the mutual difference between the diameters of the balls 17, 17 incorporated into the bearing unit 5, 5a for supporting a wheel having a disk. In this case, the mutual difference between the diameters of the balls is defined as a difference between the average diameter of the largest balls and the average diameter of the smallest balls which are incorporated into the bearing unit for supporting a wheel having a disk. When the mutual difference is increased large, the deflection of both sides 24, 24 of the disk 2 in the axial direction caused by this whirling motion is increased so that the whirling motion can not be neglected.

Referring to FIG. 3, this point will be explained below. In this connection, in the case of the bearing unit 5b for supporting a wheel having a disk shown in FIG. 3, an inner end face of the inner ring 16, which is used as an inner ring element related to the present invention, is held down by the nut 30 screwed to an inner end portion of the hub 8b which is used as a shaft member relating to the present invention, so that the inner ring 16 can be fixed to the hub 8b. In any structure including the aforementioned structure, in the case where the difference between the diameter of some balls 17 existing in the row of balls and the diameter of other balls 17, 17 is large, the hub 8, 8a, 8b whirls with respect to the outer ring 6 according to the revolution of the balls 17, 17. As exaggeratedly shown in FIG. 3, when the diameter of the ball 17a, which exists at the right lower position in the drawing, in the inner row of balls, and the diameter of the ball 17a, which exists at the left upper position in the drawing, in the outer row of balls are larger than the diameters of the other balls 17, 17 of the same row of balls, in a portion where the balls 17a, 17a, the diameters of which are large, are existing, a distance from the inner circumferential face of the outer ring 6 to the hub 8b or a distance from the inner circumferential face of the outer ring 6 to the outer circumferential face of the inner ring 16 is increased.

Therefore, as shown in the drawing, the central axis β of the hub 8b is inclined counterclockwise with respect to the central axis α of the outer ring 6. Accordingly, at the time of operation of the bearing unit 5b for supporting a wheel having a disk, when some balls 17a, 17a of the large diameter are revolved, the hub 8b whirls with respect to the outer ring 6, and the disk 2 fixed to the attaching flange 13 formed on the outer circumferential face of the hub 8b deflects in the direction of the rotary shaft (the lateral direction of FIG. 3). The deflection caused by the whirl is increased when the difference between the diameters of some balls 17a, 17a and the diameters of other balls 17, 17 is large.

Conventionally, the deflection of the disk 2 caused by the above reasons matters little because the deflection caused by the other reasons matters much. On the other hand, when the other reasons of the deflection are removed by executing the prior art described in Patent Documents 1 and 2, the deflection of the hub 8b caused by the mutual difference between the diameters of the balls 17, 17a can not be neglected. Recently, there is a demand for sufficiently suppressing the deflection of the disk 2 in order to prevent the occurrence of judder at the time of braking. However, in the case where the mutual difference of the diameters of the balls 17, 17a incorporated into the bearing unit 5, 5a, 5b for supporting a wheel having a disk is large, even if the techniques described in Patent Documents 1 and 2 are utilized, it is difficult to satisfy the above demand only by the techniques of the prior art. Accordingly, in order to sufficiently suppress the deflection of the disk 2, in addition to the use of the techniques described in Patent Documents 1 and 2, it is necessary to reduce the mutual difference of the diameters of the balls 17, 17a.

In view of the above circumstances, the bearing unit for supporting a wheel having a disk and the manufacturing method thereof of the present invention are invented. It is an object of the present invention to provide a bearing unit for supporting a wheel having a disk capable of sufficiently suppressing the deflection of a disk in order to prevent the occurrence of judder at the time of braking. It is another object of the present invention to provide a manufacturing method of manufacturing the bearing unit.

### DISCLOSURE OF THE INVENTION

The bearing unit for supporting a wheel having a disk, which is an object of the present invention, comprises a stationary ring, a rotary ring, a plurality of balls and a disk in the same manner as that of the conventional structure described before.

The stationary ring includes a stationary side raceway surface provided on the inner circumferential face or the outer circumferential face. In the state of use, the stationary ring is supported by and fixed to a suspension device.

The rotary ring includes a rotary side raceway surface on the outer or inner circumferential face opposing to the stationary side raceway surface. The rotary ring also includes a flange on the outer circumferential face.

The balls are provided between the rotary side raceway surface and the stationary side raceway surface.

Further, the disk is coupled and fixed to the flange.

In the bearing unit for supporting a wheel having a disk of the present invention, the allowance of the mutual difference between the diameters of the balls is set at a value not more than 1.5 μm. When at least the finish working is conducted on both sides of the disk under the condition that the disk is coupled and fixed to the flange after the bearing unit for supporting a wheel having a disk has been assembled, the deflection of the disk with respect to the stationary ring caused by the rotation of the rotary ring is maintained to be not more than 35 μm.

In this connection, preferably, the allowance of the mutual difference of the diameters of the balls is set at a value not more than 1.0 μm, and the deflection of the disk is maintained to be not more than 25 μm.

According to the manufacturing method of manufacturing a bearing unit for supporting a wheel having a disk of the present invention, after the bearing unit for supporting a wheel having a disk has been constituted by combining the stationary ring, the rotary ring and the balls with each other, the disk is coupled and fixed to the flange provided on the outer circumferential face of the rotary ring, and then the finish working is conducted on both sides of the disk while the rotary ring is being rotated.

In the bearing unit for supporting a wheel having a disk of the present invention, the allowance of the mutual difference between the diameters of the balls is set at a value not more than 1.5 μm (It is preferable that the allowance of the mutual difference between the diameters of the balls is 1.0 μm.). When the finish working is conducted on both sides of the disk under the condition that the disk is coupled and fixed to the flange after the bearing unit for supporting a wheel having a disk has been assembled, the deflection on both sides of the disk is maintained to be a sufficiently low value. That is, when the mutual difference of the diameters of the balls is small, the whirl of the rotary ring with respect to the stationary ring caused by the revolution of the balls can be suppressed. Therefore, the deflection of the disk, which is fixed to the rotary ring, in the direction of the rotary shaft can be suppressed to a sufficiently low value.

### BRIEF DESCRIPTION OF THE DRAWINGS

FIG. 1 is a sectional view showing an example of the state in which a bearing unit for supporting a wheel having a disk, to which the present invention can be applied, is assembled;

FIG. 2 is a sectional view showing an example of the prior art for preventing the deflection of a disk; and

FIG. 3 is a sectional view showing a bearing unit for supporting a wheel having a disk in which the state of deflection of the disk in the direction of the axis of the disk is exaggeratedly shown when the hub is inclined with respect to the outer ring in the case where the mutual difference between the diameters of the balls is large.

In the drawings, reference numeral 1 is a wheel, reference numeral 2 is a disk, reference numeral 3 is a knuckle, reference numeral 4 is a support hole, reference numerals 5, 5a and 5b are bearing units for supporting a wheel having a disk, reference numeral 6 is an outer ring, reference numeral 7 is a bolt, reference numerals 8, 8a and 8b are hubs, reference numeral 9 is a stud bolt, reference numeral 10 is a nut, reference numerals 11 and 11a are outer ring raceways, reference numeral 12 is a coupling flange, reference numeral 13 is an attaching flange, reference numerals 14a and 14b are inner ring raceways, reference numeral 15 is a small diameter step portion, reference numeral 16 is an inner ring, reference numerals 17 and 17a are balls, reference numeral 18 is a cage, reference numerals 19a and 19b are seal rings, reference numeral 20 is a spline hole, reference numeral 21 is a constant velocity joint, reference numeral 22 is a spline shaft, reference numeral 23 is a jig for driving, reference numeral 24 is a side, reference numeral 25 is a support, reference numeral 26 is a support hole, reference numeral 27 is a bolt, reference numeral 28 is a tool, reference numeral 29 is a caulking portion, reference numeral 30 is a nut, and reference numeral 31 is a displacement meter.

### BEST MODE FOR CARRYING OUT THE INVENTION

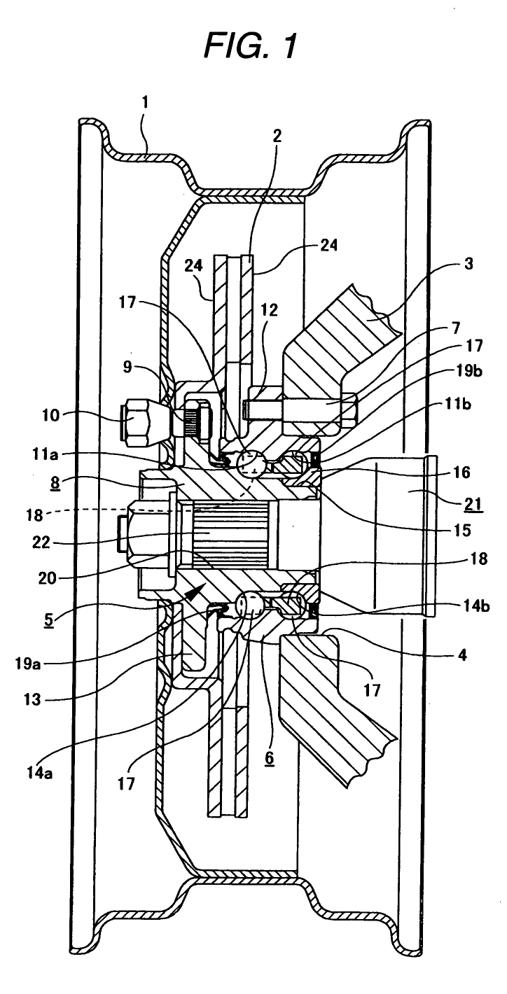

An embodiment of the present invention will be explained referring to FIGS. 1 to 3. In this connection, the present invention is characterized in that: the allowance of the mutual difference between the diameters of the balls 17, 17 incorporated into the bearing unit 5, 5a, 5b for supporting a wheel having a disk is reduced; and when the finishing work of both sides 24, 24 of the disk 2 is conducted under the condition that the disk 2 is coupled and fixed to the attaching flange 13 after the bearing unit for supporting a wheel having a disk has been assembled, the deflection of the disk 2 is suppressed to a sufficiently low value. The structure and action of the other portions are the same as those of the conventional structure described before. Therefore, the same explanations as those made before are omitted here and the characteristic portions of the present invention will be mainly explained here.

In the present embodiment, the allowance of the mutual difference between the diameters of the balls 17, 17 incorporated into the bearing unit 5, 5a, 5b for supporting a wheel having a disk is not more than 1.5 μm. That is, a difference between the average diameter of the largest balls 17 and the average diameter of the smallest balls 17 which are incorporated into the bearing unit 5, 5a, 5b for supporting a wheel having a disk is made to be not more than 1.5 μm. Therefore, for example, balls of the grade 28 stipulated by JIS B 1501 Steel Ball for Ball Bearing, in which the allowance of the mutual difference between the diameters of the balls of the same lot is not more than 1.4 μm, are used for the balls 17, 17. Further, at least the finish working is conducted on both sides 24, 24 of the disk 2, which is coupled and fixed to the attaching flange 13, after the bearing unit 5, 5a, 5b for supporting a wheel having a disk has been assembled.

Since the present invention is constituted as described above, the deflection of the disk 2 can be sufficiently suppressed. The allowance of the mutual difference between the diameters of the plurality of balls incorporated into the bearing unit 5, 5a, 5b for supporting a wheel having a disk is reduced to be not more than 1.5 μm. Therefore, when the bearing unit 5, 5a, 5b for supporting a wheel having a disk is put into practical use, the deflection of the hub 8, 8a, 8b with respect to the outer ring 6 caused by the revolution of the balls 17, 17 can be reduced. In this case, the deflection of the hub 8, 8a, 8b with respect to the outer ring 6 means the deviation between the axes α and β. Further, at least the finishing work of both sides 24, 24 of the disk 2 coupled and fixed to the attaching flange 13 provided on the outer circumferential face of the hub 8, 8a, 8b is conducted under the condition that the bearing unit 5, 5a, 5b for supporting a wheel having a disk has been assembled. Therefore, when the whirling motion caused by the aforementioned mutual difference is excluded, errors such as a shape error, a dimensional error, an assembling error and so forth caused between the coupling flange 12, which is provided on the outer circumferential face of the outer ring 6, and the disk 2 do not give an influence to the deflection of both sides 24, 24 of the disk 2.

After all, in the case of the present invention, by the synergism of the following items (1) and (2), the deflection of both sides 24, 24 of the disk 2 in the axial direction is suppressed to be a low value of 35 μm. In this connection, this deflection value is measured in a portion on each side of the disk 2, on which the portion rubs on the pad lining, wherein the portion is closest to the outer diameter.

(1) A reduction of the deflection of the hub 8, 8a, 8b according to the reduction of the mutual difference between the diameters of the balls 17, 17. That is, the mutual difference between the diameters of the balls 17, 17 is reduced to be not more than 1.5 μm.

(2) A reduction of the influence which is given to the deflection of both sides 24, 24 by the error of each portion except for the mutual difference described above, when the finish working of both sides 24, 24 of the disk 2 is conducted under the condition that the bearing unit 5, 5a, 5b for supporting a wheel having a disk has been assembled.

In this connection, when the allowance of the mutual difference of the diameters of the balls 17, 17 is not more than 1.0 μm, the deflection can be suppressed to be lower value of 25 μm. In this case, for example, balls of the grade 20 stipulated by JIS B 1501 Steel Ball for Ball Bearing, in which the allowance of the mutual difference between the diameters of the balls of the same lot is not more than 1.0 μm, are used for the balls 17, 17.

### EMBODIMENT

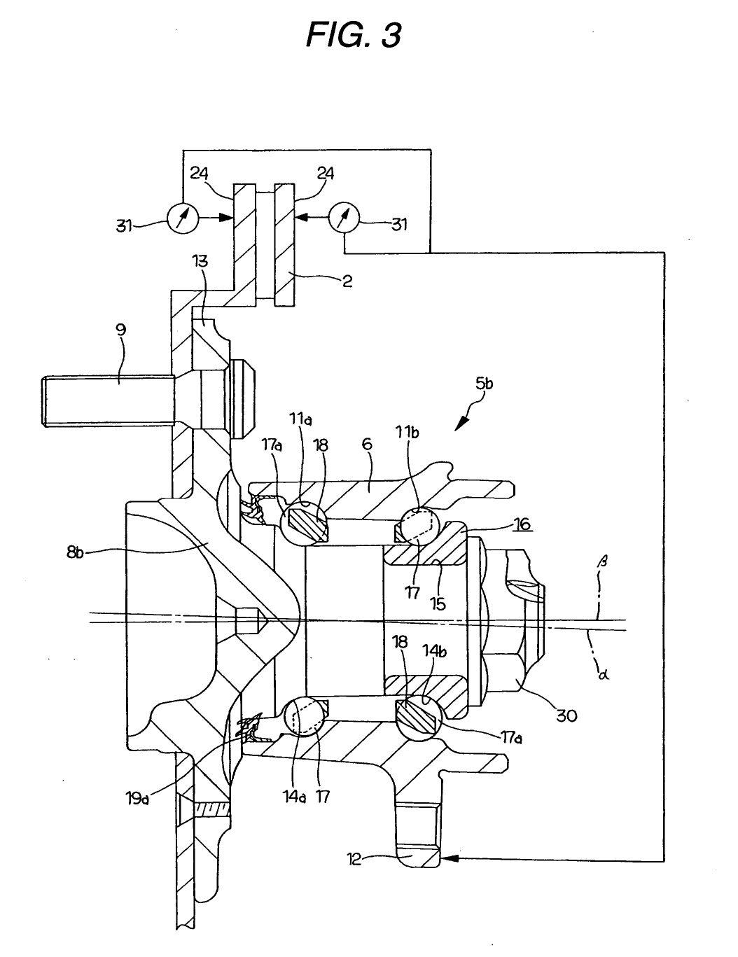

In the following Table 1, the result of an experiment made by the present inventors is shown. This experiment is made to know the influence given to the occurrence of judder by the mutual difference of the diameters of the balls 17, 17 and the deflection of both sides 24, 24 in the axial direction caused by the mutual difference. Conditions of the experiment except for the deflection of the disk 2 such as non-uniformity of the frictional state between the side of the disk 2 and the lining of the pad are set as good as possible so that the judder could not be generated. The result of the experiment made in this way is shown in Table 1. As shown in FIG. 3, values described in Table 1 related to the deflection of both sides 24, 24 of the disk in the axial direction are measured when the disk 2 is rotated under the condition that the measuring pieces of the displacement meters 31, 31 are contacted with both sides 24, 24, wherein the inside of the coupling flange 12 provided on the outer circumferential face of the outer ring 6 is used as a reference face of the measurement. Sign ⊚ in Table 1 expresses that no judder is generated, Sign ◯ in Table 1 expresses that judder is a little generated however no problems are caused, and sign x expresses that judder is generated and problems are caused.

TABLE 1

| Mutual difference between ball | | |
|---|---|---|
| diameters (μm) | Deflection of disk | Judgment |
| 1.0 | Not more than 25 μm | ⊚ |
| 1.5 | Not more than 35 μm | ◯ |
| 2.5 | Not more than 45 μm | X |

As can be seen in Table 1, when the mutual difference of the diameters of the balls 17, 17 is suppressed to be not more than 1.5 μm and the deflection of both sides 24, 24 of the disk 2 in the axial direction is suppressed to be not more than 35 μm, it is possible to suppress the judder generated at the time of braking so that passengers including a driver can not have an unpleasant feeling. Further, when the mutual difference is suppressed to be not more than 1.0 μm and the deflection is suppressed to be not more than 25 μm, it is possible to actually prevent the generation of judder at the time of braking.

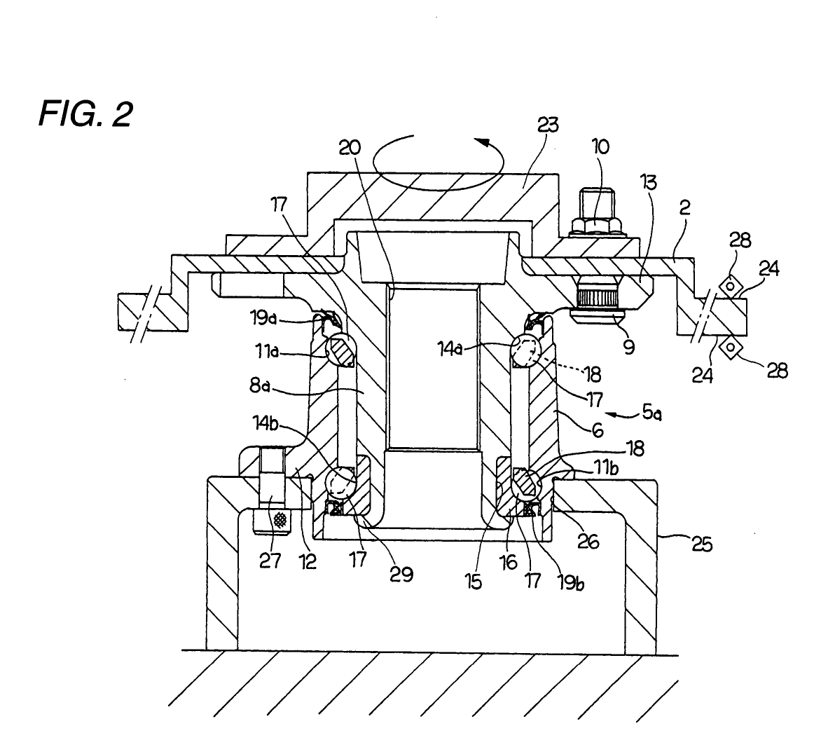

In this connection, the present invention can be applied to the bearing unit 5, 5a for supporting a wheel having a disk used for a drive wheel shown in FIGS. 1 and 2. The present invention can be also applied to the bearing unit 5b for supporting a wheel having a disk used for an idle wheel (a front wheel of FR vehicle or RR vehicle, and a rear wheel of FF vehicle) shown in FIG. 3. Further, although not shown in the drawing, the present invention can be applied to a bearing unit 5b for supporting a wheel having a disk used for an idle wheel in which the inner ring side is a stationary ring and the outer ring side is a rotary ring.

Since the bearing unit for supporting a wheel having a disk and the manufacturing method thereof are constituted as described above, the deflection of the disk can be suppressed and the generation of unpleasant noise and vibration can be reduced at the time of braking operation.

The present invention is explained in detail, referring to the specific embodiments. However, it is clear that various variations can be made by those skilled in the art without departing from the spirit and scope of the present invention.

This patent application is based on the Japanese Patent Application (Patent Application No. 2003-017047) applied on January 27th in 2003. The contents of the application is taken in here as a reference.

### INDUSTRIAL APPLICABILITY

As described above, the bearing unit for supporting a wheel having a disk of the present invention is effectively used for supporting an automobile wheel and constituting a disk brake used for braking operation.

1-5. (canceled)

6. A bearing unit for supporting a wheel having a disk comprising:
a stationary ring having a stationary side raceway surface on an inner circumferential or an outer circumferential face, supported by and fixed to a suspension device in the state of use;
a rotary ring having a rotary side raceway surface in a portion opposing to the stationary side raceway surface on an outer circumferential or an inner circumferential face, and having a flange on the outer circumferential face;
a plurality of balls provided between the rotary side raceway surface and the stationary side raceway surface; and
a disk coupled and fixed to the flange, wherein
the allowance of the mutual difference of the diameters of the balls is not more than 1.5 μm, and
at least the finish working is conducted on both sides of the disk under the condition that the disk is coupled and fixed to the flange after the bearing unit for supporting a wheel having a disk has been assembled to suppress the deflection of the disk caused by the rotation of the rotary ring to be not more than 35 μm.

7. The bearing unit for supporting a wheel having a disk according to claim 6, wherein
the allowance of the mutual difference of the diameters of the balls is not more than 1.0 μm so that the deflection of the disk is not more than 25 μm.

8. The bearing unit for supporting a wheel having a disk according to claim 6, wherein
a raceway ring of one of the stationary ring and the rotary ring is an outer ring having a plurality of rows of outer ring raceways on the inner circumferential face,
a raceway ring of the other of the stationary ring and the rotary ring is an inner ring assembling body, in which a shaft member and an inner ring element are combined with each other, having a plurality of rows of inner ring raceways on the outer circumferential face,
one inner ring raceway is formed in a middle portion of the shaft member in the axial direction,
a small diameter step portion, the diameter of which is smaller than the inner ring raceway portion, is formed in an end portion of the shaft member in the axial direction,
the inner ring element has the other inner ring raceway on the outer circumferential face, and
one end face of the inner ring element in the axial direction is held down by a caulking portion, which is formed by plastically deforming an end portion of the shaft member outward in the radial direction, under the condition that the inner ring element is outwardly engaged with the small diameter step portion.

9. The hearing unit for supporting a wheel having a disk according to claim 7, wherein
a raceway ring of one of the stationary ring and the rotary ring is an outer ring having a plurality of rows of outer ring raceways on the inner circumferential face,
a raceway ring of the other of the stationary ring and the rotary ring is an inner ring assembling body, in which a shaft member and an inner ring element are combined with each other, having a plurality of rows of inner ring raceways on the outer circumferential face,
one inner ring raceway is formed in a middle portion of the shaft member in the axial direction,
a small diameter step portion, the diameter of which is smaller than the inner ring raceway portion, is formed in an end portion of the shaft member in the axial direction,
the inner ring element has the other inner ring raceway on the outer circumferential face, and
one end face of the inner ring element in the axial direction is held down by a caulking portion, which is formed by plastically deforming an end portion of the shaft member outward in the radial direction, under the condition that the inner ring element is outwardly engaged with the small diameter step portion.

10. The manufacturing method of manufacturing a bearing unit for supporting a wheel having a disk comprising the steps of:
combining a stationary ring, a rotary ring and a plurality of balls with each other so as to constitute a bearing unit for supporting a wheel;
coupling and fixing a disk to a flange provided on an outer circumferential face of the rotary ring; and
conducting a finishing work on both sides of the disk while the rotary ring is being rotated so as to constitute a bearing unit for supporting a wheel having a disk described in claim 6.
